(19) United States
(12) Patent Application Publication
(10) Pub. No.: US 2009/0301940 A1
(43) Pub. Date: Dec. 10, 2009

(54) Apparatus and Method for Grading and Batching of Articles

(75) Inventors: Asgeir Elvarsson, Hafnarfijordur (IS); Brynjolfur Thorsson, Reykjavik (IS); Jon Vidar, Kopavogur (IS); Bjarni Andresson, Seltjarnarnes (IS); Sveinn Arnar Steinsson, Hafnarfjordur (IS); Gunnar Tjorvi Sigurdsson, Gardabaer (IS)

Correspondence Address: NIXON & VANDERHYE, PC, 901 NORTH GLEBE ROAD, 11TH FLOOR, ARLINGTON, VA, 22203, US

(73) Assignee: Marel Hf, Gardabeer (IS)

(21) Appl. No.: 11/887,757

(22) PCT Filed: Apr. 4, 2006
(86) PCT No.: PCT/IS2006/000008

§ 371 Date: Aug. 6, 2009

(30) Foreign Application Priority Data
Apr. 5, 2005 (IS) 7786

(51) Int. Cl. B07C 5/38; B07C 5/32

(52) U.S. Cl. 209/44.4

(57) ABSTRACT

An apparatus for grading and batching of articles is proposed. The apparatus consists of an in-feed station for grading of the articles into multiple “quality classes”. The articles of each of the classes are weighted by one of multiple weighing means provided. The ability to attach multiple electronic tags or labels to each of the articles makes it possible to keep track of each of the articles and allocate them according to class and weight tags into the correct batching buffer. A vertically oriented carousel conveyor transfers the articles from the weighing means using plurality of transport buckets which are suspended from the carousel support means using pivoting mechanism such that the transport buckets maintain substantially the same position as they are transported by the carousel to batching buffers located inside the carousel. When there is a complete batch in the batching buffer the batch is transported to a collection buffer via batch transport buffer formed by a group of adjacent transport buckets on the carousel conveyor as they travel towards the in-feed station. Thus the transport buckets are used twice: First, to transport individual articles to the batching buffers and the second time, to transport an entire batch to the collecting buffer. A computer system is used to control: the conveying means, the transport buckets, the batching buffer, the batch transfer buffer, the collecting buffer, and to keep track of the different electronic tags.

### TECHNICAL FIELD

The present invention relates to weighing, batching, and packaging of articles for the food industry.

### BACKGROUND ART

In various industries, articles are sold in batches satisfying various constraints. As an example, articles of non-uniform size, shape or weight, e.g. food articles such as meat, fish, fruit and vegetables, are typically handled and delivered to customers in batches having a substantially uniform characteristics such as size, shape and weight. Typically, a batch of articles must fulfill requirements defined by a contract between a delivering and a receiving party, and most often, minimum weight of the batch is a key issue. Normally, the part of the batch that exceeds the minimum weight is considered by the delivering part as a loss and is often referred to as “giveaway”, “overweight” or “over-pack”. The complexity of this task is further increased when there are multiple criteria such as weight and color, weight and size grouping, or weight, color and size grouping, for instance.

Typically, batches are formed by weighing the articles individually, e.g. as they are moved by a conveyer system across a dynamic scale. In a computer system, the weight of each item is compared with weights of a plurality of receptacles, e.g. bins wherein batches are formed. Often, the computer system uses statistical algorithms for assigning specific articles to specific bins under consideration of required minimum weight of the batch and a desire not to produce batches with more overweight, i.e. giveaway, than required under the present conditions, i.e. given the weights of the articles and the required minimum weight of the batches. When there is multiple criteria to meet, such as size grouping, batching and grading; processes are usually cascaded together requiring large facilities to house the batching lines.

### DISCLOSURE OF INVENTION

Batching of “similar” articles often involves the pre-classification of the raw material into some “quality classes”. In the present invention “quality classification” and weight batching of multiple “quality classes” is provided in a single space saving apparatus.

Accordingly, the invention in a first aspect provides an apparatus for grading and batching of articles, said apparatus comprising:
an in-feed station (1),
one or more weighing means (2),
means for attaching electronic tags to said articles,
vertically oriented carousel conveyor (3), said conveyor further comprising:
plurality of transport buckets (4),
one or more batch buffers (5), said batch buffers, each, further comprising:
one or more batching buckets (6),
one or more batch transfer buffers (7),
one or more collecting buffers (8),
one or more packing stations (9),
computing system,
   wherein said computing system is adapted to keep track of all electronic tags attached to each article.

The apparatus consists of an in-feed station for grading of the articles into multiple “quality classes”. The articles of each of the classes are weighted by one of multiple weighing means provided. After being weighted the articles are transported in transport buckets via vertically oriented carousel conveying means. The ability to attach multiple electronic tags or labels to each of the articles makes it possible to keep track of each of the articles and allocate them according to class and weight tags into the correct batching buffer.

A vertically oriented carousel conveyor for transferring the articles from the weighing means consists of a base member, with four sprockets, fastened to the base in a rectangular fashion forming two horizontal and two vertical segments. An endless supporting means is mounted on the four sprockets, and a drive means acting on one of the sprockets powers the carousel. Plurality of transport buckets are suspended from the support means using pivoting mechanism such that the transport buckets maintain substantially same position as they are transported by the carousel, through any of the vertical or horizontal segments.

The batching buffers are located in between the two horizontal segments and consists of one ore more batching buckets which collect the batch. In the case when three vertically stacked batching buckets are used, each capable of receiving ½ batch, the batching buffer can be used continuously. When the top most batching bucket has received the first ½ batch in a batch, the first ½ batch is dropped into the middle bucket where the ½ batch is stored. When the top most bucket has received the second ½ batch, the first ½ batch is dropped from the middle bucket to the bottom most bucket and the second ½ batch is dropped into the middle bucket, and the top most bucket can now start to receive the first ½ of the next batch.

When there is a complete batch in the batching buffer the batch is transported to a collection buffer via batch transport buffer formed by a group of adjacent transport buckets on the carousel conveyor as they travel the lower horizontal segment. Thus the transport buckets are used twice: First, to transport individual articles to the batching buffers and the second time, to transport an entire batch to the collecting buffer. A computer system is used to control: the conveying means, the transport buckets, the batching buffer, the batch transfer buffer, the collecting buffer, and to keep track of the different electronic tags. The computing system may consist of conventional hardware such as PC computer adapted to for use in the above described system. As well as custom made computing system composed of: central processing unit, random access memory, non-volatile memory storage, and other necessary components and interconnects. Regardless of what computing system is used, input modules and output modules, are needed as well as program code which encodes computer executable instructions which when loaded into memory and executed by the central processing unit controls the entire system via the output modules according to the input signals and the algorithms embedded in the program code.

In a second aspect, the invention provides a method for grading and batching of articles, said method comprising steps of:
grading the articles in the in-feed station (1) into multiple “quality classes”,
automatically or manually attaching “electronic quality tag” to each article,
weighing of each article in one of the weighing means (2),
attaching “electronic weight tag” to each article,
transporting the graded and weighted articles in transport buckets using vertically oriented carousel conveyor (3),
releasing the articles from the transport buckets into the batching buffer (5) associated with the “quality tag” attached to the item(s) in the transport bucket,
releasing the articles from the top most batching bucket into the middle batching bucket when the top most batching bucket has received ½ batch, and
further releasing the ½ batch from the middle batching bucket into the bottom most batching bucket when the top most batching bucket has received the second ½ batch, and then
releasing the second ½ batch of articles from the topmost batching bucket into the middle batching bucket,
releasing the entire batch from the middle and bottom most batching bucket into the batch transfer buffer (7) which is composed of several adjacent transport buckets (4),
releasing the entire batch from the batch transfer buffer (7) into one of the collecting buffer(s) (8),
releasing the batch into a packing container at one or more packing stations (9).

### BRIEF DESCRIPTION OF DRAWINGS

FIG. 1, shows side view of the apparatus for grading and batching.

FIGS. 2-5, shows four different configurations of the in-feed station.

### DETAILED DESCRIPTION

Batching of “similar” articles often involves the pre-classification of the raw material into some “quality classes”. In the present invention “quality classification” and weight batching of multiple “quality classes” is provided in a single space saving apparatus.

An apparatus for grading and batching of articles is proposed. The apparatus consists of an in-feed station for grading of the articles into multiple “quality classes”. The articles of each of the classes are weighted by one of multiple weighing means provided. The ability to attach multiple electronic tags or labels to each of the articles makes it possible to keep track of each of the articles and allocate them according to class and weight tags into the correct batching buffer. After being weighted the articles are transported in transport buckets via vertically oriented carousel conveying means.

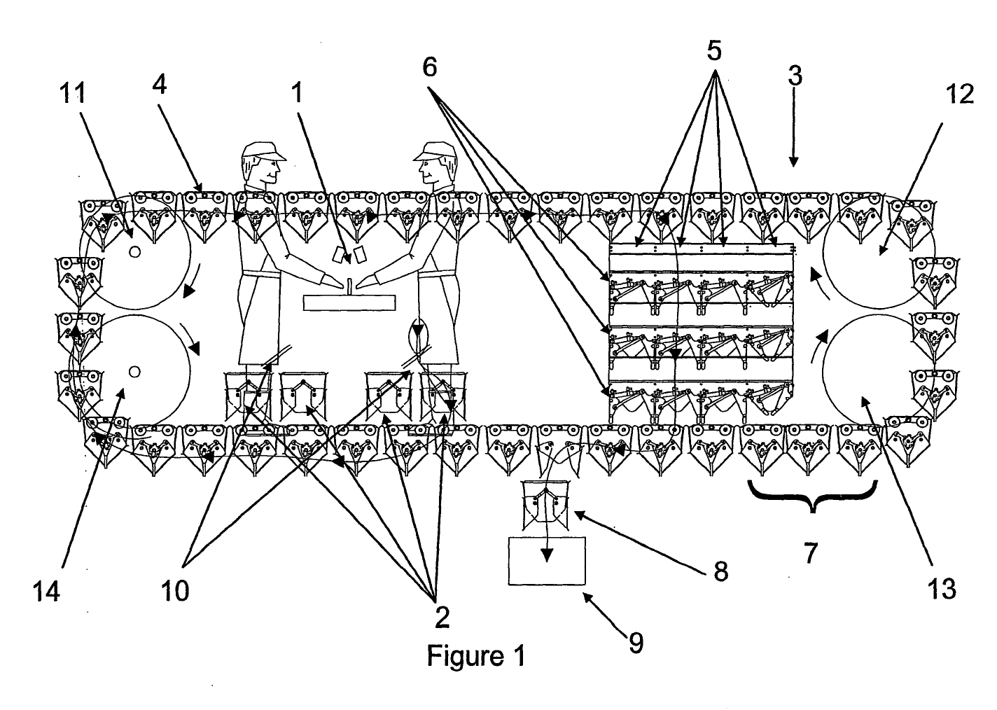

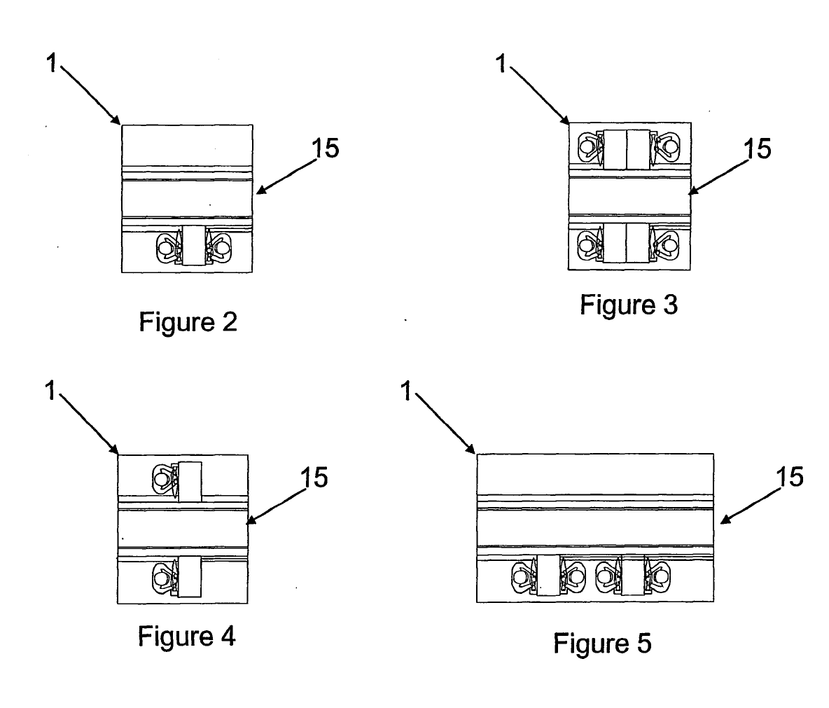

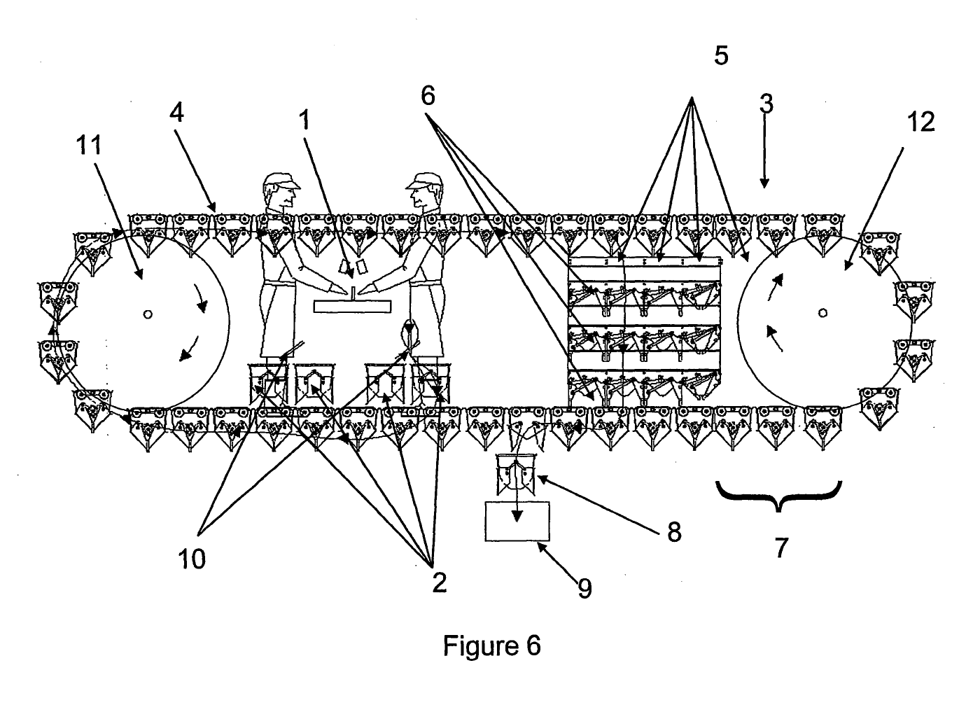

In one preferred embodiment (FIG. 1), the carousel consists of a base member, with four sprockets, (11), (12), (13), (14), fastened to the base in a rectangular fashion; the sprocket (11) being the top-left sprocket, (12) the top-right sprocket, (13) the bottom-right sprocket and (14) the bottom-left sprocket. An endless supporting means mounted on the four sprockets, and a drive means acting on one of the sprockets. A plurality of transport buckets are suspended from the support means using pivoting mechanism such that said transport buckets maintain substantially same position as they are transported by the carousel, through the upper horizontal segment from sprocket (11) to sprocket (12), through the first vertical segment from sprocket (12) to sprocket (13), through the lower horizontal segment from sprocket (13) to sprocket (14), and through the second vertical segment from sprocket (14) to sprocket (11).

In one preferred embodiment (FIG. 6), the carousel consists of a base member; with two sprockets, (11), (12), fastened to the base; the sprocket (11) being the left most sprocket, (12) the right most sprocket. An endless supporting means mounted on the two sprockets, and a drive means acting on one of the sprockets. A plurality of transport buckets are suspended from the support means using pivoting mechanism such that said transport buckets maintain substantially same position as they are transported by the carousel, through the upper horizontal segment from sprocket (11) to sprocket (12), and through the lower horizontal segment from sprocket (12) to sprocket (11).

The batching buffers are located in between the Horizontal segments and consists of one ore more batching buckets which collect the batch. In the case when three vertically stacked batching buckets are used, each capable of receiving ½ batch, the batching buffer can be used continuously.

When the top most batching bucket has received the first ½ batch in a batch, the first ½ batch is dropped into the middle bucket where the ½ batch is stored. As soon as the bottom most bucket becomes available the ½ batch is released from the middle batching bucket into the bottom most batching bucket. When the top most bucket has received the second ½ batch the entire batch is released from the middle and bottom most batching bucket into the batch transfer buffer (7) which is composed of one or more transport buckets (4),

Thus the transport buckets are used twice: Firstly, to transport individual articles to the batching buffers and secondly, to transport entire batch to the collecting buffer. A computer system is used to control: the conveying means, the transport buckets, the batching buffer, the batch transfer buffer, the collecting buffer, and to keep track of the different electronic tags. The computing system may consist of conventional hardware such as PC computer adapted to for use in the above described system. As well as custom made computing system composed of: central processing unit, random access memory, non-volatile memory storage, and other necessary components and interconnects. Regardless of what computing system is used, input modules and output modules, are needed as well as program code which encodes computer executable instructions which when loaded into memory and executed by the central processing unit controls the entire system via the output modules according to the input signals and the algorithms embedded in the program code.

1. An apparatus for grading and batching of articles, said apparatus comprising:
an in-feed station,
one or more weighing means,
means for attaching electronic tags to said articles,
vertically oriented carousel conveyor, said conveyor further comprising:
plurality of transport buckets,
one or more batch buffers, said batch buffers, each, further comprising:
one or more batching buckets,
one or more batch transfer buffers,
one or more collecting buffers,
one or more packing stations,
computing system,
wherein said computing system is adapted to keep track of all electronic tags attached to each article.

2. The apparatus according to claim 1, wherein an electronic quality tag is attached to said articles by manually operated device as said articles depart from said in-feed station.

3. The apparatus according to claim 1, wherein an electronic quality tag is attached to said articles by automatically operated device as said articles depart from said in-feed station.

4. The apparatus according to claim 1, wherein diverting means divert the article to a weighing means associated with the electronic quality tag assigned to the article.

5. The apparatus according to claim 1, wherein the operator diverts the article to a weighing means associated with the electronic quality tag assigned to the article.

6. The apparatus according to claim 1, wherein said weighing means is comprised of:
a hopper, and
an electronic scale.

7. The apparatus according to claim 1, wherein weight tag is attached to each article weighed by said weighing means.

8. The apparatus according to claim 1, wherein said carousel conveyor comprises:
a base member,
one or more sprockets, wherein said sprockets are fastened to said base member,
an endless supporting means, said supporting means mounted on said four sprockets,
drive means acting on one of said sprockets, and
plurality of said transport buckets,
wherein said transport buckets are suspended from said support means on a pivoting means such that said transport buckets maintain substantially same position as they are transported by the carousel.

9. The apparatus according to claim 1, wherein said carousel conveyor comprises:
a base member,
two sprockets, wherein said two sprockets are fastened to said base member, the sprocket being the left most sprocket, the right most sprocket
an endless supporting means, said supporting means mounted on said four sprockets,
drive means acting on one of said sprockets, and
plurality of said transport buckets,
wherein said transport buckets are suspended from said support means on a pivoting means such that said transport buckets maintain substantially same position as they are transported by the carousel, through the upper horizontal segment from sprocket to sprocket, and through the lower horizontal segment from sprocket to sprocket.

10. The apparatus according to claim 1, wherein said carousel conveyor comprises:
a base member,
four sprockets, wherein said four sprockets are fastened to said base member in rectangular fashion, being the top-left sprocket, the top-right sprocket, the bottom-right sprocket and the bottom-left sprocket,
an endless supporting means, said supporting means mounted on said four sprockets,
drive means acting on one of said sprockets, and
plurality of said transport buckets,
wherein said transport buckets are suspended from said support means on a pivoting means such that said transport buckets maintain substantially same position as they are transported by the carousel, through the upper horizontal segment from sprocket to sprocket, through the first vertical segment from sprocket to sprocket, through the lower horizontal segment from sprocket to sprocket, and through the second vertical segment from sprocket to sprocket.

11. The apparatus according to claim 1, wherein said plurality of batch buffers, each, comprise:
one or more batching buckets,
wherein batching buffer of three batching buckets provides for continuous use of said batching buffer.

12. The apparatus according to claim 1, wherein said one or more batch transfer buffers comprise the reuse of one ore more of said transport buckets as they travel said lower horizontal segment towards said in-feed station.

13. The apparatus according to claim 1, wherein said computing system comprises:
central processing unit,
random access memory,
non-volatile memory storage,
input modules,
output modules,
program code, encoding computer executable instructions,
wherein said computing system receives input signals from said input modules and executes the instructions encoded in said program code according to said input signals and preset values set by the operator.

14. A method for grading and batching of articles, said method comprising steps of:
grading the articles in the in-feed station into multiple “quality classes”,
automatically or manually attaching “electronic quality tag” to each article,
weighing of each article in one of the weighing means,
attaching “electronic weight tag” to each article,
transporting the graded and weighted articles in transport buckets using vertically oriented carousel conveyor,
releasing the articles from the transport buckets into the batching buffer associated with the “quality tag” attached to the item(s) in the transport bucket,
releasing the articles from the top most batching bucket into the middle batching bucket when the top most batching bucket has received ½ batch, and
further releasing the ½ batch from the middle batching bucket into the bottom most batching bucket as soon as it becomes available for batching, and then
releasing the second ½ batch of articles from the top most batching bucket into the middle batching bucket,
releasing the entire batch from the middle and bottom most batching bucket into the batch transfer buffer which is composed of one or more transport buckets,
releasing the entire batch from the batch transfer buffer into one of the collecting buffer,
releasing the batch into a packing container at one or more packing stations.
